(19) United States
(12) Patent Application Publication
(10) Pub. No.: US 2026/0111672 A1
(43) Pub. Date: Apr. 23, 2026

(54) DISTRIBUTED SEMANTIC COMPUTE AND COMMUNICATION CONTROL FRAMEWORK (D-SC3F)

(71) Applicant: Dell Products L.P., Round Rock, TX (US)

(72) Inventors: Hoda Dehghan, Kanata (CA); Gwenael Poitau, Montreal (CA)

(21) Appl. No.: 18/920,081

(22) Filed: Oct. 18, 2024

(51) Int. Cl. G06F 40/30

(52) U.S. Cl. CPC G06F 40/30

(57) ABSTRACT

One example method includes obtaining user interaction data generated during an interaction between a human user and a computing entity, extracting contextual information from the user interaction data, based at least in part on the contextual information, scheduling and assigning a priority to a semantic task, based at least in part on the priority, allocating resources for performance of the semantic task, generating, for the semantic task, a response to the human user, and the response is generated based in part on the contextual information, and outputting the response.

### TECHNOLOGICAL FIELD OF THE DISCLOSURE

Embodiments disclosed herein generally relate to computation and communication in a network. More particularly, at least some embodiments relate to systems, hardware, software, computer-readable media, and methods, for evaluating and improving a user experience in a network environment.

### BACKGROUND

The contemporary landscape of communication and computation in technology is increasingly complex, necessitating a system that can effectively interpret and respond to semantic content in various applications, including IoT, virtual assistants, and customer support. The challenge lies in creating a framework that can understand complex context of human interactions, prioritize tasks efficiently in dynamic environments, manage resources optimally, and adaptively enhance communication, all while continuously learning and improving from user interactions and system performance.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an architecture and workflow, according to one embodiment.

FIG. 2 discloses aspects of a method, according to one embodiment.

FIG. 3 discloses aspects of a computing entity configured and operable to perform any of the disclosed methods, processes, and operations.

### DETAILED DESCRIPTION OF SOME EXAMPLE EMBODIMENTS

Embodiments disclosed herein generally relate to computation and communication in a network. More particularly, at least some embodiments relate to systems, hardware, software, computer-readable media, and methods, for evaluating and improving a user experience in a network environment.

Example embodiments comprise an architecture and method for dealing with evolving demands, in the areas of communication and computation, in network environments, among others. Such communication may include, but is not limited to, interactions between humans and various technology platforms, such as chatbots, and virtual assistants, for example. An architecture and method according to one embodiment may comprise various modules distributed across an environment that comprises a cloud computing site, and a network that comprises one or more edge devices that are able to communicate with the cloud computing site.

One embodiment of such a method may be cooperatively performed by a cloud-hosted entity and one or more edge devices, and may comprise the following operations: receiving semantic content, such as from a human, and interpreting a meaning and intent of the semantic content; using the meaning and intent of the semantic context as a basis to prioritize and schedule a semantic task; allocating computing resources, for accomplishment of the semantic task, based on requirements and priority of the semantic task; generating, in connection with the semantic task, contextually relevant responses based on the semantic context; and, transmitting, such as to a human, the contextually relevant responses. Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments.

For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect one embodiment is that generative AI (artificial intelligence) is used for enhancing communication in a network, such as communication between a human and a virtual entity, for example. An embodiment may derive meaning and intent from a textual or verbal communication. An embodiment may generate personalized, and context-aware, communications. An embodiment may employ adaptive and predictive capabilities to generate predictions, and make adaptations, based on prior communications. An embodiment may distribute various tasks among nodes or other entities best suited to perform those tasks. Various other advantages of one or more example embodiments will be apparent from this disclosure.

### A. Aspects of an Example Context for One Embodiment

The following is a discussion of aspects of a context for various embodiments. This discussion is not intended to limit the scope of the claims or this disclosure, or the applicability of the embodiments, in any way. Reference is made in the following discussion to the documents listed hereafter, each of which is incorporated herein in its respective entirety by this reference:
[1] C. Zhang, J. Kiseleva, S. Kumar Jauhar, and R. W. White. “Grounded task prioritization with context-aware sequential ranking.” ACM Transactions on Information Systems (TOIS) 40, no. 4, pp. 1-28, 2021.
[2] F. Guo, Y. Luo, L. Yang, and Y. Zhang. “Scimine: An efficient systematic prioritization model based on richer semantic information.” In Proceedings of the 46th International ACM SIGIR Conference on Research and Development in Information Retrieval, pp. 205-215. 2023.
[3] M. Bali, K. Gupta, D. Gupta, G. Srivastava, S. Juneja, and A. Nauman. “An effective technique to schedule priority aware tasks to offload data on edge and cloud servers.” Measurement: Sensors 26, 2023.
[4] T. Dreibholz, and S. Mazumdar. “Towards a lightweight task scheduling framework for cloud and edge platform.” Internet of Things 21, 2023.

In many existing frameworks, conventional task scheduling and resource allocation are often performed without the deep contextual understanding provided by advanced NLP (natural language processing) models. These systems typically operate on predefined rules and lack the ability to dynamically adapt to changing priorities and resource availability, especially in real-time scenarios.

Conventional cloud-based AI models for communication were previously deployed primarily in cloud environments, relying on generic AI models. Unfortunately, these models were not seamlessly integrated with task prioritization or contextual comprehension modules, resulting in less personalized and contextually relevant responses. See [1] and [2].

Static learning and feedback mechanisms were characteristic of conventional systems, with limited feedback loops focused on generic system improvements rather than continuous, context-driven learning. This approach led to slower adaptation to user preferences and needs. See [3].

Centralized data processing was a feature in conventional architectures, often concentrated in cloud or data center environments. However, this centralized approach frequently resulted in higher latency, particularly in applications necessitating immediate data processing and decision-making, such as IoT and real-time analytics.

As another example, fragmented system architecture characterized some conventional approaches, operating as separate modules with limited interaction and cooperation among different components. This fragmentation led to inefficiencies and a reduction in overall system performance. See [4].

In contrast with these conventional approaches, an embodiment of the SC3F addresses these limitations by integrating various technologies across a distributed architecture, ensuring context-aware, efficient, and effective communication. The use, in an embodiment, of Large Language Models (LLMs) for deep semantic comprehension, combined with dynamic task scheduling and resource allocation at the edge, enables real-time, responsive operations.

Further, the Generative AI for Communication Enhancement (GAICE) module according to one embodiment further elevates the capability of an architecture according to one embodiment to produce personalized and contextually relevant responses. Additionally, a Feedback Loop and Learning (FLL) component according to one embodiment ensures that the system continually evolves based on user interactions and feedback. This holistic approach, which comprises distributed deployment and dynamic inter-module interaction, sets the SC3F apart from conventional technologies, offering an approach suited for the demands of modern technology landscapes.

### B. Overview of Aspects of an Embodiment

### B.1 Introduction

A Semantic Compute and Communication Control Framework (SC3F) according to one embodiment addresses challenges such as those noted above through a multi-modular approach. Situated across data centers, edge, fog computing environments, and the cloud, this framework leverages various technologies to deliver context-aware, efficient, and effective communication solutions. Each of the modules of an embodiment is addressed briefly below.

A Contextual Comprehension Module (CCM), embedded within the data center or cloud, utilizes LLMs for semantic understanding of textual or verbal inputs, such as may be generated by, and received from, a human. The CCM extracts meaning, intent, and pertinent information, for human-like interactions with technology.

At the edge, a Semantic Task Scheduler (STS) receives inputs from the CCM to schedule and prioritize semantic tasks, a useful functionality in dynamic and resource-limited environments. The Dynamic Resource Allocation (DRA) module complements this by managing computational and communication resources, ensuring tasks are executed efficiently and timely.

A cloud-hosted Generative AI for Communication Enhancement (GAICE) module synthesizes contextually relevant responses, informed by inputs from both the CCM and STS. This capability is used to generate coherent and context-appropriate communications.

An embodiment further comprises a Feedback Loop and Learning (FLL) module. Positioned in the cloud or data center, the FLL module collects feedback from user interactions and system performance, facilitating continuous improvement across all modules.

As initially outlined above, an embodiment of an architecture enables distributed deployment, ensuring scalability and reduced latency. An embodiment enables dynamic interaction across different computing and communication environments to optimize task scheduling and resource allocation, rendering the architecture well suited for use in complex settings where rapid and accurate semantic understanding is crucial. The versatility and adaptability of the architecture likewise make it well-suited for a wide range of applications, including IoT, healthcare, customer support, and virtual training, which may improve user experiences and interaction quality in these domains, among others.

### B.2 Discussion

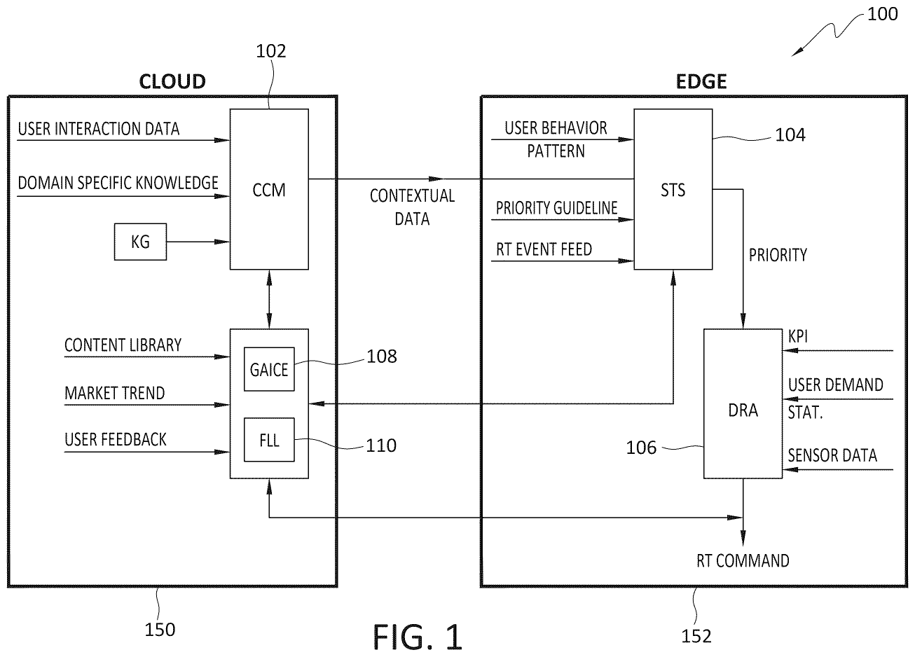

One example embodiment of a d-SC3F is denoted at 100 in FIG. 1. This d-SC3F 100, also referred to herein as an ‘architecture 100,’ comprises a comprehensive system configured and operable to address the evolving demands of communication and computation in modern technology landscapes. Comprising several interconnected modules placed in various locations such as, but not limited to, data centers, edge and fog computing environments, and the cloud, the architecture 100 addresses evolving demands for context-aware, efficient, and effective communication.

As shown in FIG. 1, the architecture 100 comprises a Contextual Comprehension Module (CCM) 102, which may be hosted in a cloud environment 150, that employs one or more LLMs to decipher complex semantic context embedded within textual or verbal inputs, unlocking meaning, intent, and pertinent information. Next, the architecture 100 further comprises an Semantic Task Scheduler (STS) module 104 and Dynamic Resource Allocation (DRA) module 106, both of which may be hosted in an edge environment 152, and which may work in tandem to optimize the scheduling and prioritization of tasks and dynamically manage computational and communication resources. Also possibly hosted in the cloud environment 150, the architecture 100 comprises a Generative AI for Communication Enhancement (GAICE) module 108 that generates contextually relevant responses, aligning seamlessly with the semantic context and task priorities. The Feedback Loop and Learning (FLL) module 110 ensures continuous system evolution by gathering feedback and facilitating improvements across the entire framework. All together, these modules comprise a holistic approach that may elevate user experiences, particularly in domains such as IoT, virtual assistants, and customer support, where understanding and responding to semantic content are paramount. Below, each of these modules is considered in further detail.

### B.2.1 Contextual Comprehension Module (CCM)

The CCM module 102, situated in a data center or cloud environment 150, serves as the foundation of the framework. It employs LLMs to interpret and understand the semantic context of communication. One reason for incorporating the CCM in the architecture 100 is the increasing need for systems to understand the meaning and intent behind textual or verbal inputs. Natural language processing and comprehension are essential for enabling more human-like interactions with technology. With this module, the system can extract meaning, intent, and relevant information from various inputs.

### B.2.2 Semantic Task Scheduler (STS)

The STS module 104, which may be located at in the edge environment 152, or in a Fog Computing level, such as a DU in an O-RAN system, receives input from the CCM module 102, including contextual understanding of incoming communication. The STS module 104 operates to schedule and prioritize semantic tasks based on their importance and urgency. In dynamic and resource-constrained environments, such as edge computing, task prioritization may be important. In an embodiment, the STS module 104 leverages the insights from the CCM module 102 to assess the significance of incoming tasks, ensuring that important tasks are handled promptly. This may be particularly useful for applications like IoT, and real-time data processing.

### B.2.3 Dynamic Resource Allocation (DRA)

Also, in one embodiment, placed in the edge environment 152 or fog computing level, the DRA module 106 communicates task priorities from the STS module 104 and manages computational and communication resources in real-time. the DRA module 106 dynamically allocates resources based on the requirements and priority of semantic tasks. Efficient resource allocation may be used to ensure that tasks are completed in a timely and resource-optimal manner. By dynamically allocating resources based on task priorities and requirements, the DRA module 106 may maximize resource utilization and minimizes latency, which may be useful for responsive and efficient communication.

### B.2.4 Generative AI for Communication Enhancement (GAICE)

The GAICE module 108 which, in an embodiment, may be hosted in the cloud site 105 or data center, may operate to generate contextually relevant and coherent responses or representations based on the semantic context. It receives inputs from both the CCM module 102 for contextual understanding, and the STS module 104 for task prioritization. In many communication scenarios, generating appropriate responses that align with the semantic context is challenging. The GAICE module 108 may address this challenge by leveraging the insights provided by the CCM module 102 and the STS module 104 to create responses that are contextually meaningful and in line with the prioritized tasks, ultimately enhancing the quality of communication.

### B.2.5 Feedback Loop and Learning (FLL)

In an embodiment, the FLL module 110 may be located in the cloud environment 150 or a data center, and may operate to collect feedback from the communication process, including user evaluations and system interactions. The FLL module 110 may provide feedback to all other components of the architecture 100, including the CCM module 102, the STS module 104, the DRA module 106, and the GAICE module 108. Continuous learning and adaptation are useful for system improvement. The FLL module 110 may help to ensure that the entire architecture 100 evolves based on the feedback gathered from users and system interactions. This iterative process leads to enhancements in understanding, task prioritization, resource allocation, and response generation, making the architecture 100 more effective over time.

B.3 Generative AI for communication enhancement

With continued reference to the example of FIG. 1, an embodiment of the GAICE module 108 harnesses the power of generative AI to create responses that are contextually relevant and highly personalized. One element of the GAICE module 108 is its ability to synthesize inputs from two components of the framework, namely, the CCM module 102 and the STS module 104.

B.3.1 Integration with CCM and STS

The integration of the GAICE module 108 with the CCM module 102 enables the GAICE module 108 to have a deep understanding of the semantic context. The CCM module 102, equipped with language models, interprets and unravels the complexities embedded within textual or verbal communication. This process ensures that the GAICE module 108 responses are not just accurate in terms of content but are also aligned with the intent of the user, as embodied in a user communication, and the subtleties of the interaction.

Moreover, the incorporation of insights from the STS module enables the GAICE module 108 to prioritize its responses effectively. STS, operating predominantly at the Edge or Fog Computing levels, assesses the urgency and significance of tasks. By receiving this prioritized information, GAICE can tailor its responses to address the most immediate and critical needs of the user first, which is particularly beneficial in dynamic environments where prioritization is key.

### B.3.2 Personalization and Context-Awareness

One aspect of the GAICE module 108 is its capacity for personalization and context-aware communication. In scenarios where user interaction is paramount, such as in customer service or virtual assistants, the ability of the GAICE module 108 to provide tailored responses may significantly enhance the user experience. In an embodiment, the GAICE module 108 can adapt its language, tone, and content based on the user profile, past interactions, and current context, making the communication more engaging and effective.

### B.3.3 Adaptive and Predictive Responses

An embodiment of the GAICE module 108 also comprises adaptive and predictive capabilities. For example, the GAICE module 108 not only reacts to the current context but can also anticipate future needs or queries based on the ongoing interaction trajectory and historical data. This predictive aspect ensures that the communication is not just reactive but also proactive, offering information and solutions even before the user explicitly requests them.

### B.3.4 Application in Diverse Domains

The versatility of the GAICE module 108 enables it to be effectively implemented in various domains, from IoT and healthcare to customer support and virtual training. In each of these domains, the ability to provide precise, context-aware, and personalized communication is crucial. For instance, in a healthcare setting, the GAICE module 108 could enhance patient interaction by providing personalized health advice or reminders, while in customer support, the GAICE module 108 could offer solutions that are aligned with the customer history and preferences.

### B.3.5 Continuous Learning and Evolution

As a final example, an embodiment of the GAICE module 108 is configured and operable as a learning system. For example, the GAICE module 108 continually evolves based on user feedback and interactions. This aspect ensures that the GAICE module 108 becomes more refined and effective over time, constantly improving its communication strategies and response quality. Thus, an embodiment of the GAICE module 108 is an addition to the architecture. The of the GAICE module 108 to generate contextually relevant, prioritized, and personalized responses, combined with its adaptive and predictive capabilities, are a significant departure from conventional approaches in the realm of AI-driven compute and communication control. The GAICE module 108 continuous learning and evolution capabilities further ensure its long-term effectiveness and adaptability across a wide range of applications.

### B.4 Distributed Deployment of LLM-Based CCM

The Distributed Deployment of the functionality of the CCM module 102 may significantly enhance the efficiency and effectiveness of the CCM module 102. This feature may enable the deployment of the CCM module 102 across multi-layered communication and computing domains, including data centers, edge, fog computing settings, and the cloud. Such a distributed deployment strategy enables parallel processing, where different nodes of the CCM module 102 can work simultaneously on separate tasks, thus greatly increasing processing speed and efficiency. This approach is particularly beneficial for scalability, enabling the architecture to add more nodes as demand increases without needing to overhaul the entire setup. This scalability is useful for applications that expect to grow over time, and/or which experience variable demand.

In an embodiment, each node in this distributed system may be customized according to its specific operational needs. For instance, a node in an edge computing environment might be optimized for rapid, low-latency tasks, while a cloud-based node might handle more complex, resource-intensive processing tasks. The integration of robust data synchronization mechanisms is a component of this feature. Such integration may ensure consistency across all nodes, meaning that every part of the architecture 100 has access to the latest and most accurate data. This synchronization may enable the architecture 100 to make informed and coherent decisions.

In an embodiment, advanced techniques such as distributed databases or blockchain technology may be utilized for data synchronization, ensuring prompt and accurate reflection of updates across the system. This may be particularly important in real-time applications, such as IoT devices or real-time analytics, where decisions need to be based on the most current information to maintain accuracy and relevance. An embodiment of the architecture 100 may also be equipped to handle discrepancies or conflicts in data that might arise from its distributed nature, involving algorithms to identify and resolve inconsistencies, thereby maintaining the integrity of the data.

Moreover, the distributed nature of the architecture 100, and/or one or more of its modules, may significantly reduce latency by processing data closer to where that data is generated, or needed. This reduction in latency can be important for time-sensitive applications, where processing and decision-making delays can have significant impacts.

Thus, as explained above, the distributed deployment feature of an embodiment is a useful aspect of the architecture 100, enabling the architecture 100 to be adaptable, scalable, and efficient. This capability enables the architecture 100 to address a wide range of applications, from large-scale data processing to real-time decision-making, making the architecture 100 an exceptionally robust approach for contemporary technological challenges.

### C. Detailed Discussion

Following in this section is a detailed explanation of each system architecture component, that will consider technological foundations, required interfaces, deployed algorithms for each section, and their interactions with one another. This overview is intended to provide a broader understanding of how these modules work together synergistically to create a robust and efficient system.

### C.1 Advanced Technologies and Solutions

### C.1.1 Contextual Comprehension Module (CCM)

The CCM module, or simply, ‘CCM,’ an example of which is referenced at 102 in FIG. 1, employs data preprocessing methods to handle diverse data formats, including speech recognition for verbal inputs and text normalization for written content. The CCM incorporates machine learning algorithms that enable the module to learn from new data continuously, enhancing its accuracy and relevance over time. As well, an embodiment of the CCM may utilize advanced NLP algorithms, such as BERT (Bidirectional Encoder Representations from Transformers) or similar models for understanding language complexities. Additionally, this CCM module is configured and operable to perform sentiment analysis, entity recognition, and contextual embeddings.

For some applications, a distributed CCM configuration may be used with modules having different latency requirements. The following examples are illustrative.
Distributed Deployment: The CCM is deployed in a distributed manner across data centers and cloud environments. This distribution enables parallel processing of inputs, enhancing scalability and reducing latency.
Data Synchronization: In a distributed setup, data synchronization mechanisms ensure consistency across various nodes. Techniques such as distributed databases or blockchain may be used for synchronization.

### C.1.2 Semantic Task Scheduler (STS)

In an embodiment, the STS module, an example of which is referenced at 104 in FIG. 1, utilizes complex algorithms to determine task priority, which might include factors such as task urgency, historical data patterns, computational requirements, user preferences, and predictive analytics. The STS module implements developments in edge computing, such as edge AI for example, to facilitate faster decision-making closer to the data source, reducing latency significantly. The STS module may interface with edge devices and sensors for real-time data collection and task scheduling. Finally, an embodiment of the STS module not only schedules tasks but also communicates with other modules to provide real-time updates on task status and system load, facilitating more coordinated system behavior.

### C.1.3 Dynamic Resource Allocation (DRA)

In an embodiment, a DRA module, such as the DRA module 106 of FIG. 1, employs techniques such as resource pooling and virtualization to optimize the utilization of computational and communication resources. Constrained Reinforcement learning (C-RL) is a viable candidate for deployment in the DRA module to optimize both compute and communication. In operation, the DRA module receives priority data from STS and allocates resources accordingly. The interface between the DRA module and the STS module enables the maintenance of system balance and performance. An embodiment of the DRA module uses predictive models to anticipate future resource demands, enabling proactive resource allocation that can adapt to changing conditions in the network or other environment. As well, an embodiment of the DRA module may also help to reduce energy consumption in the network, which may be important in sustainable computing environments.

### C.1.4 Generative AI for Communication Enhancement (GAICE)

In one embodiment, the GAICE module may be primarily cloud-based, taking advantage of the high computational power available in a cloud environment to run complex AI models. The GAICE module incorporates advanced generative models such as GPT (Generative Pre-trained Transformer) or similar architectures to generate human-like responses. These models are trained on vast datasets to generate coherent and contextually appropriate responses. The GAICE module also provides customization features. For example, an embodiment of the GAICE module is operable to tailor responses based on user profiles and past interactions, offering a more personalized communication experience to a user, or users.

### C.1.5 Feedback Loop and Learning (FLL)

In an embodiment, an FLL module incorporates machine learning algorithms for analyzing feedback and improving system performance. The FLL module uses ML (machine learning) techniques to adapt and evolve system responses based on user feedback. The FLL module interfaces with all other modules, such as the modules disclosed in FIG. 1, to collect performance data, user feedback, and system interactions. This data is then used to train and refine the system. Following are some further example functionalities of an FLL module.

An embodiment of an FLL module may incorporate analytics and reporting functionalities. These may implement advanced analytics to process feedback data, offering insights into system performance and user satisfaction. As another example, an embodiment of an FLL module may incorporate a user experience focus. For example, the FLL module may prioritize improvements that directly enhance user experience, ensuring that the architecture remains user-centric.

### C.2 Interfaces and Input Mechanisms

C.2.1 In one embodiment, user interfaces provide direct input to the CCM module through textual or voice commands. These interfaces are configured to be intuitive and user-friendly, catering to a wide range of users.

C.2.2 In IoT applications, sensor data is an important input, especially for the STS module and the DRA module. In one embodiment, sensors of various types provide real-time data that is used for task scheduling and resource allocation.

C.2.3 In one embodiment, inter-module communications use APIs (application program interfaces) and web services facilitate data transfer. By leveraging these algorithms, deployment strategies, and interfaces, the architecture 100 may efficiently process and respond to vast amounts of data in real-time, making the architecture and methods disclosed herein well suited for use in complex environments where rapid and accurate semantic understanding is important.

### D. Aspects of One Example Use Case for an Embodiment

Following is a discussion of an example use case for one embodiment that involves Mixed Reality (MR) training simulation for medical procedures. More particularly, consider MR training simulation for medical procedures in the context of virtual reality (VR) and mixed reality (MR) applications to understand the inputs to each module and the potential outputs it could generate. In this example scenario, a distributed CCM module is used with modules having different latency requirements.

D.1 Distributed CCM (d-CCM)
D.1.1 Example Inputs of d-CCM

In an embodiment, various inputs may be provided to a d-CCM module. Such inputs may include, but are not limited to:
User Queries and Commands: Spoken or typed instructions and questions by the user during the simulation, such as “How do I make an incision?” or “Show me where to inject.”
User Behavior Data: Gestures, actions, and interactions of the user within the VR/MR environment, like selecting tools, navigating menus, or performing a simulated task.
Environmental Context: The current scenario or stage of the simulation, e.g., a surgical procedure, emergency response training, etc.
Physiological Data: Biometric inputs such as heart rate, eye tracking, or hand tremors, which can indicate user stress levels, focus, and proficiency.
Learning History: Previous interactions, errors, successes, and feedback from past sessions to tailor the training experience.
Collaborative Input: In cases of multi-user simulations, inputs from other users in the same scenario, including their actions, queries, and communications.
   D.1.2 Example Inputs of d-CCM

In an embodiment, a d-CCM module may generate various outputs. Such outputs may include, but are not limited to:
Interpreted Intent: Understanding the user's objectives, such as seeking guidance on a specific medical procedure or looking for performance feedback.
Contextual Meaning: Extracting the significance of user actions and queries within the context of the medical simulation. For example, determining that a user is struggling with a particular step in a procedure.
Actionable Insights: Suggestions or instructions based on the user's actions and queries, such as recommending a tutorial for a specific surgical technique.
Adaptive Responses: Modifying the simulation in real-time to suit the user's skill level or learning needs, like simplifying a task for a beginner.
Predictive Analytics: Anticipating future training needs or potential errors based on current performance and historical data.
Personalized Feedback: Generating tailored feedback on the user's performance, highlighting areas of strength and improvement.
Collaborative Dynamics Understanding: In multi-user scenarios, providing insights on team dynamics, coordination, and communication effectiveness.

These example inputs and outputs to/from a d-CCM illustrate how the CCM can process complex and diverse data in a VR/MR training simulation for medical procedures. The ability of the d-CCM module to interpret and respond to various types of inputs significantly enhances the learning experience, making it more adaptive, interactive, and efficient.

### D.2 Semantic Task Scheduler (STS)

In the example MR training simulation for medical procedures, the STS module plays a role in organizing and prioritizing tasks based on the complex data provided by the CCM. Following are some examples of the inputs to the STS module, and the potential outputs generated by the STS module in this particular context.

### D.2.2 Example Inputs to STS

In an embodiment, an STS module may receive various inputs. Such inputs may include, but are not limited to:
Interpreted Intent and Meaning: The STS receives detailed interpretations of the user intent and the contextual meaning of their actions from the CCM. This includes understanding specific requests or needs during the simulation.
Actionable Insights: These are recommendations or suggestions generated by the CCM, and received by the STS module based on the user actions and queries. The STS module uses this information to prioritize which tasks should be addressed first.
Adaptive Response Data: Information on how the simulation should adapt in response to the user performance, such as which new scenarios to introduce, or which tutorials to recommend.
Predictive Analytics Information: Insights about potential future training needs or difficulties the user might encounter, enabling the STS to schedule preparatory tasks or learning modules in advance.
Personalized Feedback Requirements: Based on the user performance, the CCM might generate, and provide as input to the STS module, personalized feedback that needs to be scheduled for delivery at appropriate times during the simulation.
Collaborative Dynamics Data: In multi-user scenarios, the STS may receive data about team interactions and communication, which it uses to schedule joint tasks or collaborative learning opportunities.

In an embodiment, an STS module may generate various outputs. Such outputs may include, but are not limited to:
Task Prioritization: The STS module prioritizes tasks and actions within the VR/MR simulation, determining which user needs should be addressed immediately and which can be deferred.
Scheduled Learning Modules: Based on the user performance and learning curve, the STS module schedules relevant learning modules or training scenarios.
Resource Allocation Recommendations: The STS module may provide suggestions on how to allocate computational and instructional resources effectively, based on the prioritized tasks.
Adaptive Learning Plan: Creation of a dynamic and adaptive learning plan that evolves based on the user progress and changing needs.
Feedback Delivery Schedule: A timetable for when to deliver personalized feedback and insights to the user, ensuring that it is provided at the most impactful moments.
Collaborative Task Scheduling: In multi-user simulations, the STS organizes and schedules tasks that require teamwork, ensuring effective collaboration and learning.

By processing these inputs and generating these outputs, an embodiment of the STS module may ensure that the MR training simulation runs smoothly, efficiently, and effectively, adapting to the user needs in real-time and optimizing the learning experience.

### D.3 Dynamic Resource Allocation (DRA)

In an embodiment, the DRA module plays a role in optimizing both computational and communication resources based on the task priorities set by the Semantic Task Scheduler (STS) module. Below is a detailed list of inputs for the DRA module and the potential outputs the DRA module may generate in this scenario.

### D.3.1 Example Inputs to DRA

In an embodiment, a DRA module may receive various inputs. Such inputs may include, but are not limited to:
Task Priorities from STS: Detailed information about the importance and urgency of various tasks within the simulation, as determined by the STS.
Resource Allocation Recommendations: Suggestions from the STS module regarding how computational and communication resources might be best allocated to different tasks.
Latency Requirements for Each Task: Information on the time-sensitive nature of various tasks, crucial for real-time simulations like VR/MR.
Current Resource Utilization Data: Real-time data about how computational and communication resources are currently being used in the system.
Adaptive Learning Plan Details: Information from the STS module about the dynamic learning path, which may require varying levels of resource allocation over time.
User Interaction Data: Metrics and data points related to how the user is interacting with the simulation, which can influence resource allocation decisions.
Network Traffic Information: Details about the current state of network traffic, especially important for cloud-based components of the VR/MR system.

### D.3.2 Example Outputs of a DRA Module

In an embodiment, a DRA module may generate various outputs. Such outputs may include, but are not limited to:
Resource Allocation Decisions: Specific decisions about how computational power and bandwidth are distributed among various tasks within the simulation.
Load Balancing Strategies: Strategies to distribute resources effectively across different nodes and tasks to meet the latency requirements and ensure smooth simulation performance.
Resource Optimization Reports: Analysis and reports on how the resource allocation is impacting the performance of the simulation, both from computational and communication perspectives.
Adaptive Resource Scaling: Adjusting the allocation of resources in real-time based on changing demands and priorities within the simulation.
Network Congestion Management: Actions taken to manage and mitigate network congestion, ensuring efficient communication resource usage.
Predictive Resource Allocation: Anticipating future resource needs based on current trends and user interactions, preparing the system for upcoming demands.

By processing these inputs and generating these outputs, an embodiment of the DRA module may ensure that both computational and communication resources are optimized, leading to an efficient and effective VR/MR training experience. This optimization helps in maintaining high performance and user engagement, especially in complex simulations that require real-time interactions and feedback.

### D.4 Generative AI for Communication Enhancement

In the MR training simulation for the example use case of medical procedures, the GAICE module operates to enhance the overall user experience by generating appropriate responses and representations. In an embodiment, the GAICE module takes inputs from the CCM module, the STS module, and the DRA module. Below is a detailed list of inputs for the GAICE module and the potential outputs the GAICE module may generate in this scenario, along with how and where these outputs could be used in the application.

### D.4.1 Example Inputs to a GAICE Module

In an embodiment, a GAICE module may receive various inputs. Such inputs may include, but are not limited to:
Contextual Understanding from CCM: Detailed semantic understanding of the user's actions, queries, and behavior in the simulation.
Task Priorities and Insights from STS: Information about prioritized tasks and actionable insights, which guides the generation of relevant responses.
Adaptive Learning and Feedback Data: Adjustments and recommendations based on the user performance and learning curve, as identified by the STS.
Resource Allocation Information from DRA: Data on the current allocation of computational and communication resources, which might influence the complexity and timing of generated responses.
User Interaction Metrics: Real-time data on how users are interacting with the simulation, which can help tailor the responses more effectively.
Network and System Performance Data: Information on the current state of the system and network, which might impact the delivery and format of responses.

### D.4.2 Example Outputs of a GAICE Module

In an embodiment, a GAICE module may generate various outputs. Such outputs may include, but are not limited to:
Contextually Relevant Responses: Generated answers or guidance that align with the user current activities and queries in the simulation.
Adaptive Instructional Content: Customized tutorials or instructional content based on the user learning needs and performance. These tutorials guide users through medical procedures, providing step-by-step assistance and clarifications as needed.
Real-Time (RT) Feedback: Immediate feedback on user actions, enhancing the learning experience by providing timely and relevant information. RT feedback may be useful for immediate correction or reinforcement of user actions during the simulation, enhancing skill acquisition and retention.
Predictive Guidance: Anticipatory advice or suggestions based on the user past interactions and current trajectory in the simulation. This guidance may be used to preemptively address potential challenges or difficulties the user might face, smoothing the learning curve.
Dynamic Scenario Generation: Creation of new, adaptive scenarios or challenges in the simulation based on user performance and learning progress. It enhances the adaptability of the simulation, creating new learning environments or challenges that are tailored to the user's evolving skill level.
Collaborative Communication Facilitation: In multi-user simulations, generating communication prompts or aids to enhance team dynamics and collaboration. An embodiment of the GAICE module may provide communication set up scenarios that require collaborative problem-solving.

By processing these inputs and generating these outputs, an embodiment of the GAICE module may significantly enriches the MR training experience, making it more interactive, personalized, and effective. The outputs may be used to create a dynamic and engaging learning environment that adapts to the user needs and enhances their skill development in medical procedures.

### D.5 Feedback Loop and Learning (FLL)

In the MR training simulation for medical procedures, the FLL module is used for continuous improvement and adaptation of the system. The FLL module gathers data from the outputs of the CCM module, the STS module, the DRA module, and the GAICE module. Below is a detailed list of inputs for the FLL module and the potential outputs the FLL module may generate in this scenario, along with how and where these outputs could be used in the application.

### D.5.1 Example Inputs to an FLL Module

In an embodiment, an FLL module may receive various inputs. Such inputs may include, but are not limited to:
User Responses and Interactions: Feedback on the effectiveness of responses and interactions generated by GAICE, based on user engagement and performance.
System Performance Metrics: Data on the efficiency and effectiveness of resource allocation from DRA, including any issues or bottlenecks.
Task Completion and Prioritization Efficacy: Information from STS on how well tasks were prioritized and completed, and the impact on the user's learning experience.
Semantic Understanding Accuracy: Data from CCM on the accuracy and relevance of the interpreted user intents, meanings, and actionable insights.
User Learning Progress and Outcomes: Data on the user's progress, skill acquisition, and overall performance in the simulation.
User Feedback: Direct feedback from users on their experience, including what they found helpful or challenging.

### D.5.2 Example Outputs of an FLL Module

In an embodiment, an FLL module may generate various outputs. Such outputs may include, but are not limited to:
Improved Semantic Analysis Algorithms: Suggestions for enhancing the accuracy and depth of semantic analysis in CCM.
Task Scheduling Optimization: Recommendations for refining the task prioritization and scheduling algorithms in STS.
Resource Allocation Adjustments: Insights for better managing computational and communication resources in DRA.
Enhanced Communication Strategies: Feedback for GAICE on how to improve the generation of responses, instructional content, and real-time feedback.
User Experience Enhancements: Overall insights into how the user experience can be improved across all modules.
Adaptive Learning Strategies: Recommendations for all modules to better adapt to individual user needs and learning styles.

By processing these inputs and generating these outputs, an embodiment of the FLL module ensures that the MR training system is continually learning and adapting, based on real-world usage and feedback. This ongoing improvement cycle enhances the effectiveness and efficiency of each module, ultimately leading to a more engaging, personalized, and successful training experience for users.

### D.6 Glossary

Following is a glossary of some terms used herein. This glossary is not intended to limit the scope of this disclosure, or of any claims, in any way.

| Term | Definition |
|---|---|
| BERT | Bidirectional Encoder Representations from Transformers |
| CCM | Contextual Comprehension Module |
| C-RL | Constrained Reinforcement Learning |
| d-CCM | Distributed Contextual Comprehension Module |
| d-SC3F | Distributed Semantic Compute and Communication Control |
| | Framework |
| DRA | Dynamic Resource Allocation |
| DU | Distributed Unit |
| FLL | Feedback Loop and Learning |
| GAICE | Generative AI Communication Enhancement |
| LLM | Large Language Model |
| MR | Mixed Reality |
| NLP | Natural Language Processing |
| RT | Real Time |
| SC3F | Semantic Compute and Communication Control Framework |
| VR | Virtual Reality |

### E. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

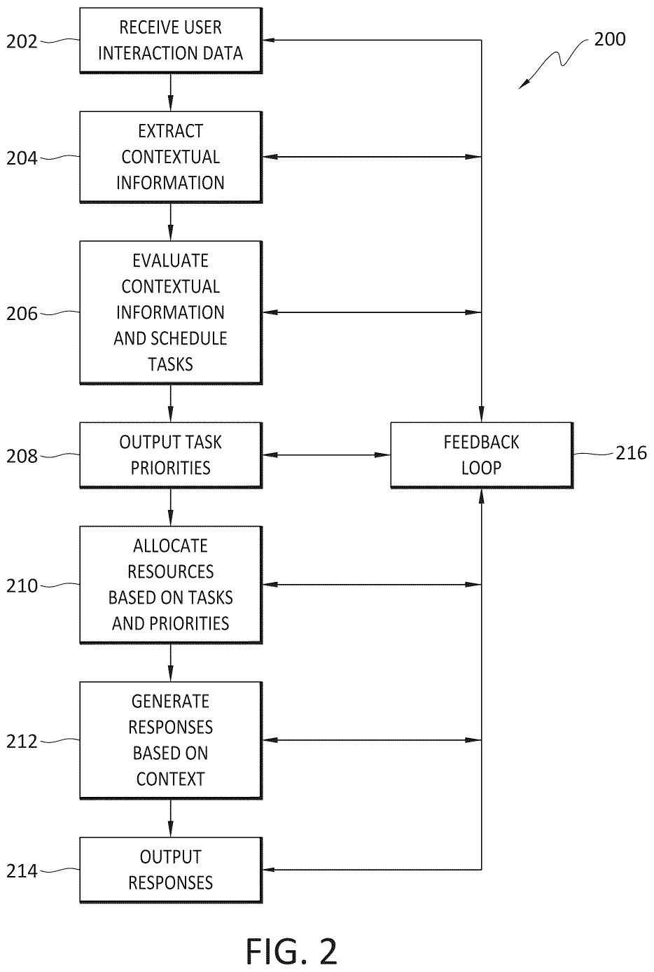

Directing attention now to FIG. 2, there is disclosed a method 200 according to one embodiment. In an embodiment, the method 200 may be cooperatively by various entities including, but not limited to, CCM, STS, DRA, GAICE, and FLL, modules. These modules may be hosted at various locations including, but not limited to, a cloud computing site, a cloud storage site, and an edge environment that comprises various types of edge devices. In an embodiment, at least the CCM module may be configured to interact with a user, such as a human user for example, either directly, or by way of an intermediary computing entity.

In an embodiment, the method 200 may begin with collection or receipt 202 of human user interaction data, such as data concerning the interaction of a human with a virtual entity such as a chatbot or virtual assistant, for example. Various contextual information concerning the interaction(s) may then be extracted 204, and/or otherwise obtained, from the interaction data.

The contextual information that was extracted 204 may then be evaluated 206. The outcome of the evaluation may comprise an identification of tasks, and their respective priorities relative to each other. The task priorities may then be output 208, and used as a basis to allocate 210 resources for the corresponding tasks.

Next, responses, possibly respectively corresponding to each of the tasks, may be generated 212. Each of the responses may be generated in connection with a particular user interaction or user input and, as such, may be context-specific. The responses may then be output 214 and communicated to one or more respective users.

Finally, as shown in the example of FIG. 2, a feedback loop 216 may be provided. The feedback loop 216 may comprise communication between a feedback entity and the various entities that may perform the operations of the method 200. As shown, this communication may be two-way communication. Based on the feedback, one or more of the entities may modify the way in which it operates. In an embodiment, communication between the feedback entity and the various other entities may take place on an ongoing, continuous, basis.

### F. Further Example Embodiments

Following are some further example embodiments. These are presented only by way of example and are not intended to limit the scope of this disclosure or the claims in any way.

Embodiment 1. A method, comprising: obtaining user interaction data generated during an interaction between a human user and a computing entity; extracting contextual information from the user interaction data; based at least in part on the contextual information, scheduling and assigning a priority to a semantic task; based at least in part on the priority, allocating resources for performance of the semantic task; generating, for the semantic task, a response to the human user, and the response is generated based in part on the contextual information; and outputting the response.

Embodiment 2. The method as recited in claim 1, wherein the contextual information is extracted using NLP (natural language processing) and comprises a meaning and/or intent of the human user.

Embodiment 3. The method as recited in claim 1, wherein the generating of the response is performed using generative AI (artificial intelligence) implemented by an LLM (large language model) and is also based on the priority that was assigned to the semantic task.

Embodiment 4. The method as recited in claim 1, wherein the response is personalized to the human user.

Embodiment 5. The method as recited in claim 1, wherein a language, tone, and content, of the response are specific to the human user.

Embodiment 6. The method as recited in claim 1, wherein content of the response anticipates a particular communication from the human user but which has not yet been provided by the human user.

Embodiment 7. The method as recited in claim 1, wherein the obtaining of the user interaction data, and the extracting of the contextual information, are performed by a scalable platform that comprises multiple distributed nodes.

Embodiment 8. The method as recited in claim 1, wherein the semantic task is one of a group that comprises multiple semantic tasks, and each of the semantic tasks is optimally performable at a different respective node of a group of nodes.

Embodiment 9. The method as recited in claim 1, wherein domain specific knowledge is used as a basis for the extracting of the contextual information.

Embodiment 10. The method as recited in claim 1, wherein the response is based in part on feedback received in connection with a prior user interaction.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

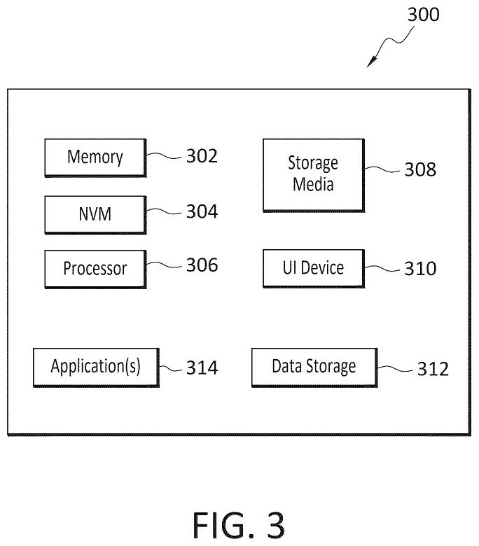

With reference briefly now to FIG. 3, any one or more of the entities disclosed, or implied, by FIGS. 1-2, and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
obtaining user interaction data generated during an interaction between a human user and a computing entity;
extracting contextual information from the user interaction data;
based at least in part on the contextual information, scheduling and assigning a priority to a semantic task;
based at least in part on the priority, allocating resources for performance of the semantic task;
generating, for the semantic task, a response to the human user, and the response is generated based in part on the contextual information; and
outputting the response.

2. The method as recited in claim 1, wherein the contextual information is extracted using NLP (natural language processing) and comprises a meaning and/or intent of the human user.

3. The method as recited in claim 1, wherein the generating of the response is performed using generative AI (artificial intelligence) implemented by an LLM (large language model) and is also based on the priority that was assigned to the semantic task.

4. The method as recited in claim 1, wherein the response is personalized to the human user.

5. The method as recited in claim 1, wherein a language, tone, and content, of the response are specific to the human user.

6. The method as recited in claim 1, wherein content of the response anticipates a particular communication from the human user but which has not yet been provided by the human user.

7. The method as recited in claim 1, wherein the obtaining of the user interaction data, and the extracting of the contextual information, are performed by a scalable platform that comprises multiple distributed nodes.

8. The method as recited in claim 1, wherein the semantic task is one of a group that comprises multiple semantic tasks, and each of the semantic tasks is optimally performable at a different respective node of a group of nodes.

9. The method as recited in claim 1, wherein domain specific knowledge is used as a basis for the extracting of the contextual information.

10. The method as recited in claim 1, wherein the response is based in part on feedback received in connection with a prior user interaction.

11. A non-transitory storage medium having stored therein instructions that are executable by one or more hardware processors to perform operations comprising:
obtaining user interaction data generated during an interaction between a human user and a computing entity;
extracting contextual information from the user interaction data;
based at least in part on the contextual information, scheduling and assigning a priority to a semantic task;
based at least in part on the priority, allocating resources for performance of the semantic task;
generating, for the semantic task, a response to the human user, and the response is generated based in part on the contextual information; and
outputting the response.

12. The non-transitory storage medium as recited in claim 11, wherein the contextual information is extracted using NLP (natural language processing) and comprises a meaning and/or intent of the human user.

13. The non-transitory storage medium as recited in claim 11, wherein the generating of the response is performed using generative AI (artificial intelligence) implemented by an LLM (large language model) and is also based on the priority that was assigned to the semantic task.

14. The non-transitory storage medium as recited in claim 11, wherein the response is personalized to the human user.

15. The non-transitory storage medium as recited in claim 11, wherein a language, tone, and content, of the response are specific to the human user.

16. The non-transitory storage medium as recited in claim 11, wherein content of the response anticipates a particular communication from the human user but which has not yet been provided by the human user.

17. The non-transitory storage medium as recited in claim 11, wherein the obtaining of the user interaction data, and the extracting of the contextual information, are performed by a scalable platform that comprises multiple distributed nodes.

18. The non-transitory storage medium as recited in claim 11, wherein the semantic task is one of a group that comprises multiple semantic tasks, and each of the semantic tasks is optimally performable at a different respective node of a group of nodes.

19. The non-transitory storage medium as recited in claim 11, wherein domain specific knowledge is used as a basis for the extracting of the contextual information.

20. The non-transitory storage medium as recited in claim 11, wherein the response is based in part on feedback received in connection with a prior user interaction.
